(19) United States
(12) Patent Application Publication
(10) Pub. No.: US 2017/0342176 A1
(43) Pub. Date: Nov. 30, 2017

(54) CLOSURE HAVING EXCELLENT ORGANOLEPTIC PERFORMANCE

(71) Applicant: NOVA Chemicals (International) S.A., Fribourg (CH)

(72) Inventors: XiaoChuan Wang, Calgary (CA); Mehdi Keshtkar, Calgary (CA); Renee Laurel Anseeuw, Calgary (CA); Ian Robert Gibbons, Calgary (CA); Gilbert Alexander Arnould, Calgary (CA)

(73) Assignee: NOVA Chemicals (International) S.A., Fribourg (CH)

(21) Appl. No.: 15/602,479

(22) Filed: May 23, 2017

(30) Foreign Application Priority Data
May 30, 2016 (CA) 2931488

(51) Int. Cl. C08F 210/16

(52) U.S. Cl. CPC C08F 210/16; C08F 2500/13; C08F 2500/04; C08F 2500/07

(57) ABSTRACT

A closure comprising a polyethylene copolymer which has a density of from 0.940 to 0.962 g/cm³, a melt index I₂ of less 1.5 g/10 min, high levels of unsaturation and low catalyst component residues, has excellent organoleptic properties.

The present disclosure is directed to closures made from polyethylene compositions which have a density in the range of from about 0.940 to about 0.962 g/cm³, a melt index of ≦1.5 g/10 min, high levels or unsaturation and low catalyst residues. The closures are made using, for example, continuous compression molding.

One-piece closures, such as screw caps for bottles have recently been made from polyethylene resins. The use of high density resin is required if the closures are to have sufficient stiffness, while broader molecular weight distributions are desirable to impart good flow properties and to improve environmental stress crack resistance (ESCR).

Polyethylene blends produced with conventional Ziegler-Natta or Phillips type catalysts systems can be made having suitably high density and ESCR properties; see for example, WO 00/71615 and U.S. Pat. No. 5,981,664.

Examples of high density multimodal polyethylene blends made using conventional catalyst systems for the manufacture of caps or closures are taught in U.S. patent application Nos. 2005/0004315A1; 2005/0267249A1; as well as WO 2006/048253, WO 2006/048254, WO 2007/060007; and EP 2,017,302A1.

Further high density, multimodal polyethylene blends made by employing conventional Ziegler-Natta catalysts are disclosed in U.S. patent application Nos. 2009/0062463A1; 2009/0198018; 2009/0203848 and in WO 2007/130515, WO 2008/136849 and WO 2010/088265.

U.S. Pat. No. 7,790,826 describes polymers blends as well as a single component ethylene/1-hexene copolymer resin which can be used in the formation of a closure. The single component resins are made in the gas phase with a chromium based catalyst.

Polyethylene compositions made with traditional chromium or Ziegler-Natta catalysts often contain significant quantities of catalyst metal residues. The presence of metal residues can impart undesirable organoleptic properties, a potential problem when making closures which will come into contact with consumable foodstuffs and liquids.

There remains a need for closures made of low cost materials having improved organoleptic properties.

We now report that closures made from simple polyethylene copolymers having high levels of unsaturation and low levels of catalyst residue have improved organoleptic properties.

An embodiment of the disclosure is a closure comprising a polyethylene copolymer which has a density of from 0.940 to 0.962 g/cm³, a melt index I₂ of less 1.5 g/10 min, an amount of terminal unsaturation of at least 0.45 per 1000 carbon atoms, fewer than 0.9 parts per million of titanium and fewer than 0.4 parts per million of chromium.

In an embodiment of the disclosure, a closure comprises a polyethylene copolymer having a density of from 0.947 to 0.960 g/cm³.

In an embodiment of the disclosure, a closure comprises a polyethylene copolymer comprising polymerized ethylene and 1-butene.

In an embodiment of the disclosure, a closure comprises a polyethylene copolymer having a molecular weight distribution of from 5.0 to 16.0.

In an embodiment of the disclosure a closure is made by continuous compression molding.

In an embodiment of the disclosure, a closure comprises a polyethylene copolymer having an environmental stress crack resistance, ESCR, at Condition B at 10% IGEPAL and 50° C. of from 10 to 100 hours.

In an embodiment of the disclosure, a closure comprises a polyethylene copolymer having a total amount of unsaturation of at least 0.50 per 1000 carbon atoms.

In an embodiment of the disclosure, a closure comprises a polyethylene copolymer having an average water taste testing score of greater than 4.

In an embodiment of the disclosure, a closure comprises a polyethylene copolymer which is made in a solution phase polymerization reactor.

In an embodiment of the disclosure, a closure comprises a polyethylene copolymer which is made with a Ziegler-Natta catalyst.

### BRIEF DESCRIPTION OF THE DRAWINGS

FIG. 1 shows a gel permeation chromatograph of the polymer used in Example 3.

FIG. 2 shows a gel permeation chromatograph of the polymer used in Example 4.

The present disclosure is related to caps and closures for bottles and to the polyethylene compositions and processes used to manufacture them.

The terms “cap” and “closure” are used interchangeably in the current disclosure, and both connote any suitably shaped molded article for enclosing, sealing, closing or covering etc., a suitably shaped opening, a suitably molded aperture, an open necked structure or the like used in combination with a container, a bottle, a jar and the like.

### Polyethylene Composition

The present disclosure contemplates the use of polyethylene homopolymer compositions, collectively, “polyethylene homopolymer(s)” or the use of polyethylene copolymer compositions, collectively “polyethylene copolymers(s)” in the formation of caps and closures, so long as the polyethylene composition has a density of from 0.947 to 0.960 g/cm³, a melt index of ≦1.5 g/10 min, has low levels of catalyst residues and has high levels of unsaturation.

As used herein, the term “polyethylene homopolymer” is meant to convey its conventional meaning, that the polymer is prepared using only ethylene as a polymerizable monomer. In contrast, the term “polyethylene copolymer” is meant to convey its conventional meaning, that the polymer is prepared using both ethylene and one or more than one alpha-olefin comonomer.

In an embodiment of the disclosure, a polyethylene copolymer as described below is used in the formation of caps and closures.

### The Polyethylene Copolymer

In an embodiment of the present disclosure, the polyethylene copolymer has a density of from 0.940 to 0.962 g/cm³ or falls within any narrower range within this range, or is any number within this range. For example, in further embodiments of the present disclosure the polyethylene copolymer has a density of from 0.945 to 0.960 g/cm³, from 0.947 to 0.960 g/cm³, or from 0.947 to 0.959 g/cm³, or from 0.949 to 0.959 g/cm³

In an embodiment of the disclosure, the polyethylene copolymer has a melt index, I₂ as determined according to ASTM D1238 (2.16 kg/190° C.) of less than about 1.5 g/10 min, or less than 1.25 g/10 min, or less than about 1.0 g/10 min, or less than 0.75 g/10 min, or less than about 0.5 g/10 min. In further embodiments of the disclosure, the polyethylene copolymer has a melt index, I₂ as determined according to ASTM D1238 (2.16 kg/190° C.) of from 0.01 to 1.5 g/10 min, or from about 0.1 to about 1.5 g/10 min, or from about 0.1 to about 1.25 g/10 min, or from about 0.1 to about 1.0 g/10 min, or from about 0.1 to about 0.8 g/10 min, or from 0.2 to about 1.0 g/10 min, or from about 0.2 to about 0.8 g/10 min.

In an embodiment of the present disclosure, the polyethylene copolymer has a unmoral profile in a gel permeation chromatograph obtained according to the method of ASTM D6474-99. In an embodiment of the present disclosure, the polyethylene copolymer has a biocidal profile in a gel permeation chromatograph obtained according to the method of ASTM D6474-99. In an embodiment of the present disclosure, the polyethylene copolymer has a multimodal profile in a gel permeation chromatograph obtained according to the method of ASTM D6474-99.

The term “unmoral” is herein defined to mean there will be one significant peak or maximum evident in the G.P.-curve. A unmoral profile includes a broad unmoral profile. Alternatively, the term “unmoral” connotes the presence of a single maxima in a molecular weight distribution curve generated according to the method of ASTM D6474-99. In contrast, by the term “biocidal” it is meant that there will be a secondary peak or shoulder evident in a G.P.-curve which represents a higher or lower molecular weight component (i.e. The molecular weight distribution, can be said to have two maxima in a molecular weight distribution curve). Alternatively, the term “biocidal” connotes the presence of two maxima in a molecular weight distribution curve generated according to the method of ASTM D6474-99. The term “multi-modal” denotes the presence of two or more maxima, including peaks or shoulders in a molecular weight distribution curve generated according to the method of ASTM D6474-99.

In an embodiment of the present disclosure, the polyethylene copolymer is a polyethylene copolymer having a conventional or normal comonomer distribution. By the term “normal comonomer distribution”, it is meant that the proportion of comonomer (and hence side chain branching) decreases with increasing molecular weight. Such a normal comonomer distribution can be measured using well known methods such as for example gel permeation chromatography with Fourier Transform Intra-Red detection.

In an embodiment of the disclosure, the polyethylene copolymer is neither a post reactor melt blend nor a post reactor dry blend. That is, in an embodiment of the disclosure, the polyethylene copolymer is not the product of melt blending or dry blending two different polymer compositions outside of a polymerization reactor.

In an embodiment of the disclosure, the polyethylene copolymer is not a blend of two or more different polymer compositions made in one or more than one polymerization reactor using two or more different polymerization catalysts.

In an embodiment of the present disclosure, the polyethylene copolymer has an ESCR Condition B (10% IGEPAL) of at least about 1 hour.

In an embodiment of the present disclosure, the polyethylene copolymer has an ESCR Condition B (10% IGEPAL) of from at least about 10 hours (hrs).

In an embodiment of the present disclosure, the polyethylene copolymer has an ESCR Condition B (10% IGEPAL) of from at least about 20 hours.

In an embodiment of the present disclosure, the polyethylene copolymer has an ESCR Condition B (10% IGEPAL) of from about 1 to about 100 hours.

In an embodiment of the present disclosure, the polyethylene copolymer has an ESCR Condition B (10% IGEPAL) of from about 10 to about 100 hours.

In an embodiment of the present disclosure, the polyethylene copolymer has an ESCR Condition B (10% IGEPAL) of from about 10 to about 75 hours.

In an embodiment of the disclosure, the polyethylene copolymer has a weight average molecular weight (mW) from about 90,000 to about 300,000 (g/mol). In other embodiments of the disclosure the polyethylene copolymer has a weight average molecular weight (mW) from about 90,000, to about 250,000, or from about 90,000 to about 225,000, or from about 90,000 to about 200,000, or from about 100,000 to about 300,000, or from about 100,000 to about 250,000, or from about 110,000 to about 225,000, or from about 125,000 to about 200,000, or from about 125,000 to about 190,000.

In an embodiment of the disclosure, the polyethylene copolymer has a molecular weight distribution (M_{w}/Mₙ) of from about 5.0 to about 16.0. In further embodiments of the disclosure, the polyethylene copolymer has a molecular weight distribution (M_{w}/Mₙ) of from about 6.0 to about 15.0, or from about 6.5 to about 14.0, or from about 6.5 to about 13.5.

In an embodiment of the disclosure, the polyethylene copolymer has an amount of terminal unsaturation of at least 0.35 per 1000 carbons (or per carbon atom), or at least 0.40 per 1000 carbons, or at least 0.45 per 1000 carbons, or greater than 0.45 per 1000 carbons, or at least 0.50 per 1000 carbons, or greater than 0.50 per 1000 carbons, or at least 0.55 per 1000 carbons, or greater than 0.55 per thousand carbons, or at least 0.60 per 1000 carbons, or greater than 0.60 per 1000 carbons, or at least 0.65 per 1000 carbons, or greater than 0.65 per 1000 carbons, or at least 0.70 per 1000 carbons, or greater than 0.70 per thousand carbons.

In an embodiment of the disclosure, the polyethylene copolymer has a total amount of unsaturation (which includes internal, side chain, and terminal unsaturation) of at least 0.40 per 1000 carbons (or per carbon atom), or at least 0.45 per 1000 carbons, or at least 0.50 per 1000 carbons, or greater than 0.50 per 1000 carbons, or at least 0.55 per 1000 carbons, or greater than 0.55 per 1000 carbons, or at least 0.60 per 1000 carbons, or greater than 0.60 per thousand carbons, or at least 0.65 per 1000 carbons, or greater than 0.65 per 1000 carbons, or at least 0.70 per 1000 carbons, or greater than 0.70 per 1000 carbons, or at least 0.75 per 1000 carbons, or greater than 0.75 per 1000 carbons.

Suitable alpha olefin comonomers for polymerization with ethylene to make the polyethylene copolymer include 1-butene, 1-hexene and 1-octene.

In an embodiment of the disclosure, the polyethylene copolymer comprises from about 0.1 to about 5 weight %, in some cases less than about 3 weight %, in other instances less than about 1.5 weight % of an alpha olefin selected from 1-butene, 1-hexene, 1-octene and mixtures thereof.

In an embodiment of the disclosure, the polyethylene copolymer comprises polymerized ethylene and 1-butene.

Examples of polyethylene copolymers which are useful in the present disclosure include by way of non-limiting example, STAIR® 17A, and STAIR 58A, each of which is commercially available from NOVA Chemicals Corporation.

In an embodiment of the disclosure, the polyethylene copolymers suitable for use in the present disclosure may be prepared using conventional polymerization processes, non-limiting examples of which include gas phase, slurry and solution phase polymerization processes. Such processes are well known to those skilled in the art.

In an embodiment of the disclosure, the polyethylene copolymers may be prepared using conventional catalysts. Some non-limiting examples of conventional catalysts include chrome based catalysts and Ziegler-Natta catalysts. Such catalysts are well known to those skilled in the art.

Solution and slurry polymerization processes are generally conducted in the presence of an inert hydrocarbon solvent/diluent, such for example, a C₄₋₁₂ hydrocarbon which may be unsubstituted or substituted by a C₁₋₄ alkyl group, such as, butane, pentane, hexane, heptane, octane, cyclohexane, methylcyclohexane or hydrogenated naphtha. A non-limiting example of a commercial solvent is ISOBAR® E (C₈₋₁₂ aliphatic solvent, Exxon Chemical Co.). The monomers are dissolved in the solvent/diluent.

A slurry polymerization process may be conducted at temperatures from about 20° C. To about 180° C., or from 80° C. To about 150° C., and the polyethylene polymer being made is insoluble in the liquid hydrocarbon diluent.

A solution polymerization process may be conducted at temperatures of from about 180° C. To about 250° C., or from about 180° C. To about 230° C., and the polyethylene polymer being made is soluble in the liquid hydrocarbon phase (e.g. The solvent).

A gas phase polymerization process can be carried out in either a fluidized bed or a stirred bed reactor. A gas phase polymerization, in some embodiments, involves a gaseous mixture comprising from about 0 to about 15 mole % of hydrogen, from about 0 to about 30 mole % of one or more C₃₋₈ alpha-olefins, from about 15 to about 100 mole % of ethylene, and from about 0 to about 75 mole % of an inert gas at a temperature from about 50° C. to about 120° C., or from about 75° C. to about 110° C.

Suitable alpha olefin which may be polymerized with ethylene in the case of a polyethylene copolymer are C3-8 alpha olefin such as one or more of 1-butene, 1-hexene, and 1-octene.

In an embodiment of the disclosure, the polyethylene copolymer is prepared by contacting ethylene and optionally an alpha-olefin with a polymerization catalyst under solution polymerization conditions.

In an embodiment of the disclosure, the polyethylene copolymer is made in a single polymerization reactor using only one polymerization catalyst.

In an embodiment of the disclosure, the polyethylene copolymer is made in a multiple (i.e., two or more) polymerization reactors using only one polymerization catalyst.

In an embodiment of the disclosure the polyethylene copolymer is made in a single solution polymerization reactor using only one polymerization catalyst.

In an embodiment of the disclosure, the polyethylene copolymer is made in multiple (i.e., two or more) solution polymerization reactors using only one polymerization catalyst.

In an embodiment of the disclosure, the polyethylene copolymer is made in a single solution polymerization reactor using only one polymerization catalyst, and the polymerization catalyst is a Ziegler-Natta catalyst.

In an embodiment of the disclosure, the polyethylene copolymer is made in multiple (i.e. Two or more) solution polymerization reactors using only one polymerization catalyst, and the polymerization catalyst is a Ziegler-Natta catalyst.

In an embodiment of the disclosure, the polyethylene copolymer is made with a Ziegler-Natta polymerization catalyst.

In an embodiment of the disclosure, the polyethylene copolymer is made in a solution polymerization process using a Ziegler-Natta catalyst.

The term “Ziegler-Natta” catalyst is well known to those skilled in the art and is used herein to convey its conventional meaning. A Ziegler-Natta catalyst may be supported or unsupported.

By way of non-limiting example, Ziegler-Natta catalysts comprise at least one transition metal compound of a transition metal selected from groups 3, 4, or 5 of the Periodic Table (using IUPAC nomenclature) and an organoaluminum component that is defined by the formula:

Al(X′)ₐ(OR)_{b}(R)_{c}

wherein: X′ is a halide (for example chlorine); OR is an alkoxy or aryloxy group; R is a hydrocarbyl (for example an alkyl having from 1 to 10 carbon atoms); and a, b, or c are each 0, 1, 2, or 3 with the provisos, a+b+c=3 and b+≧1. As will be appreciated by those skilled in the art of ethylene polymerization, conventional Ziegler Natta catalysts may also incorporate additional components such as an electron donor or support materials. For example, an amine electron donor or a magnesium compound or a magnesium alkyl such as butyl ethyl magnesium and a halide source (which may be, for example, a chloride such as tertiary butyl chloride) and which may form a support matrix (such as, MgCl₂ or chloride deficient MgCl₂ both of which are well known in the art). Ziegler-Natta catalyst components may be combined off-line or they may be combined in-line on route to a polymerization zone or they may be combined directly within a polymerization reactor zone. Ziegler-Natta catalysts may also be “tempered” (i.e. heat treated) prior to being introduced to a reactor (again, using techniques which are well known to those skilled in the art and published in the literature).

In an embodiment of the disclosure, the polyethylene copolymer has less than 1.5 ppm, or less than 1.3 ppm, or ≦1.0 ppm, or ≦0.9 ppm, or ≦0.8, or less than 0.8 ppm, or ≦0.75 ppm, or less than 0.50 ppm of titanium (Ti) present.

In an embodiment of the disclosure, the polyethylene copolymer has less than 1.5 ppm, or less than 1.3 ppm, or ≦1.0 ppm, or ≦0.9 ppm, or ≦0.8 ppm, or ≦0.75, or ≦0.60 ppm of aluminum (Al) present.

In an embodiment of the disclosure, the polyethylene copolymer has less than 0.5 ppm, or less than 0.4 ppm, or ≦0.3 ppm, or ≦0.2 ppm, or ≦0.15 ppm, or ≦0.1 ppm, of chlorine (Cl) present.

In an embodiment of the disclosure, the polyethylene copolymer has less than 4.0 ppm, or less than 3.0 ppm, or ≦2.5 ppm, or ≦2.0 ppm, of magnesium (Mg) present.

In an embodiment of the disclosure, the polyethylene copolymer comprises one or more nucleating agents.

In an embodiment of the disclosure, the polyethylene copolymer comprises a nucleating agent or a mixture of nucleating agents.

The polyethylene copolymer may be compounded or dry-blended either by a manufacturer or a converter (e.g., the company converting the resin pellets into the final product). The compounded or dry-blended polyethylene polymers may contain fillers, pigments and other additives. In some embodiments, fillers are inert additives, such as, clay, talc, TiO₂ and calcium carbonate, which may be added to the polyolefin in amounts from about 0 weight % up to about 50 weight %, in some cases, less than 30 weight % of fillers are added. The compounded or dry-blended polyethylene polymers may contain antioxidants, heat and light stabilizers, such as, combinations of one or more of hindered phenols, phosphates, phosphites and phosphonites, for example, in amounts of less than about 0.5 weight % based on the weight of the polyethylene polymer. Pigments may also be added to the polyethylene polymers in small amounts. Non-limiting examples of pigments include carbon black, phthalocyanine blue, Congo red, titanium yellow, etc.

The polyethylene copolymers may contain a nucleating agent or a mixture of nucleating agents in amounts of from about 5 parts per million (ppm) to about 10,000 ppm based on the weight of the polyethylene polymer. The nucleating agent may be selected from dibenzylidene sorbitol, di(p-methylbenzylidene) sorbitol, di(o-methylbenzylidene) sorbitol, di(p-ethylbenzylidene) sorbitol, bis(3,4-dimethylbenzylidene) sorbitol, bis(3,4-diethylbenzylidene) sorbitol and bis(trimethylbenzylidene) sorbitol. One commercially available nucleating agent is bis(3,4-dimethylbenzylidene) sorbitol.

Optionally, additives can be added to the polyethylene copolymer. Additives can be added to the polyethylene copolymer during an extrusion or compounding step, but other suitable known methods will be apparent to a person skilled in the art. The additives can be added as is or as part of a separate polymer component added during an extrusion or compounding step. Suitable additives are known in the art and include but are not-limited to antioxidants, phosphites and phosphonites, nitrones, antacids, UV light stabilizers, UV absorbers, metal deactivators, dyes, fillers and reinforcing agents, nano-scale organic or inorganic materials, antistatic agents, lubricating agents such as calcium stearates, slip additives such as erucimide and behenamide, and nucleating agents (including nucleators, pigments or any other chemicals which may provide a nucleating effect to the polyethylene copolymer). The additives that can be optionally added are typically added in amount of up to 20 weight percent (wt %).

One or more nucleating agent(s) may be introduced into the polyethylene copolymer by kneading a mixture of the polymer, usually in powder or pellet form, with the nucleating agent, which may be utilized alone or in the form of a concentrate containing further additives such as stabilizers, pigments, antistatics, UV stabilizers and fillers. It may be a material which is wetted or absorbed by the polymer, which may be insoluble in the polymer and which may have a melting point higher than that of the polymer, and it may be homogeneously dispersible in the polymer melt in as fine a form as possible (1 to 10 μm). Compounds known to have a nucleating capacity for polyolefins include salts of aliphatic monobasic or dibasic acids or arylalkyl acids, such as sodium succinate, or aluminum phenylacetate; and alkali metal or aluminum salts of aromatic or alicyclic carboxylic acids such as sodium β-naphthoate, or sodium benzoate.

Examples of nucleating agents which are commercially available and which may be added to the polyethylene copolymer are dibenzylidene sorbital esters (such as the products sold under the trademark Millad 3988™ by Milliken Chemical and IRGACLEAR® by Ciba Specialty Chemicals). Further examples of nucleating agents which may added to the polyethylene copolymer include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophtalic acid structure (or “HHPA” structure) as disclosed in U.S. Pat. No. 6,599,971 (Dotson et al., to Milliken); and phosphate esters, such as those disclosed in U.S. Pat. No. 5,342,868 and those sold under the trade names NA-11 and NA-21 by Asahi Denka Kogyo, cyclic dicarboxylates and the salts thereof, such as the divalent metal or metalloid salts, (for example, calcium salts) of the HHPA structures disclosed in U.S. Pat. No. 6,599,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,599,971. An example is 1,2-cyclohexanedicarboxylicacid, calcium salt (CAS registry number 491589-22-1). Still further examples of nucleating agents which may added to the polyethylene copolymer include those disclosed in WO 2015/042561, WO 2015/042563, WO 2015/042562 and WO 2011/050042.

Many of the above described nucleating agents may be difficult to mix with the polyethylene copolymer that is being nucleated and it is known to use dispersion aids, such as, for example, zinc stearate, to mitigate this problem.

In an embodiment of the disclosure, the nucleating agents are well dispersed in the polyethylene copolymer.

In an embodiment of the disclosure, the amount of nucleating agent used is comparatively small—from 5 to 3000 parts by million per weight (based on the weight of the polyethylene copolymer) so it will be appreciated by those skilled in the art that some care must be taken to ensure that the nucleating agent is well dispersed. In an embodiment of the disclosure, the nucleating agent is added in finely divided form (less than 50 microns, especially less than 10 microns) to the polyethylene copolymer to facilitate mixing. In some embodiments, this type of “physical blend” (i.e., a mixture of the nucleating agent and the resin in solid form) may be preferable to the use of a “masterbatch” of the nucleator (where the term “masterbatch” refers to the practice of first melt mixing the additive—the nucleator, in this case—with a small amount of the polyethylene copolymer resin—then melt mixing the “masterbatch” with the remaining bulk of the polyethylene copolymer resin).

In an embodiment of the disclosure, an additive such as nucleating agent may be added to the polyethylene copolymer by way of a “masterbatch”, where the term “masterbatch” refers to the practice of first melt mixing the additive (e.g., a nucleator) with a small amount of the polyethylene copolymer, followed by melt mixing the “masterbatch” with the remaining bulk of the polyethylene copolymer.

In an embodiment of the disclosure, the polyethylene copolymer further comprises a nucleating agent or a mixture of nucleating agents.

In embodiments where the polyethylene composition is used in closures typically used for food contact applications, the additive package must meet the appropriate food regulations, such as, the FDA regulations in the United States.

In an embodiment of the disclosure, the polyethylene copolymers described above are used in the formation of molded articles. For example, articles formed by continuous compression molding and injection molding are contemplated. Such articles include, for example, caps, hinged caps, screw caps, closures and hinged closures for bottles.

### The Closure

In the present disclosure, the polyethylene copolymers described above are used in the formation of closures. For example, articles formed by continuous compression molding are contemplated. Such articles include, for example, caps, screw caps, and closures for bottles.

In an embodiment of the disclosure, the polyethylene copolymers described above are used in the formation of a closure for bottles, containers, pouches and the like. For example, closures for bottles formed by continuous compression molding are contemplated. Such closures include, for example, hinged caps, hinged screw caps, hinged snap-top caps, and hinged closures for bottles, containers, pouches and the like. Closures for use in hot fill or aseptic fill applications are also contemplated by the present disclosure.

In an embodiment of the disclosure, a closure (or cap) is a screw cap for a bottle, container, pouches and the like.

In an embodiment of the disclosure, a closure (or cap) is a snap closure for a bottle, container, pouches and the like.

In an embodiment of the disclosure, a closure (or cap) comprises a hinge made of the same material as the rest of the closure (or cap).

In an embodiment of the disclosure, a closure (or cap) is hinged closure.

In an embodiment of the disclosure, a closure (or cap) is a hinged closure for bottles, containers, pouches and the like.

In an embodiment of the disclosure, a closure (or cap) is a flip-top hinge closure, such as a flip-top hinge closure for use on a plastic ketchup bottle or similar containers containing foodstuffs.

When a closure is a hinged closure, it comprises a hinged component and in some embodiments consists of at least two bodies which are connected by a thinner section that acts as a hinge allowing the at least two bodies to bend from an initially molded position. The thinner section may be continuous or web-like, wide or narrow.

A useful closure (for bottles, containers and the like) is a hinged closure and may consist of two bodies joined to each other by at least one thinner bendable portion (e.g., the two bodies can be joined by a single bridging portion, or more than one bridging portion, or by a webbed portion, etc.). A first body may contain a dispensing hole and which may snap onto or screw onto a container to cover a container opening (e.g., a bottle opening) while a second body may serve as a snap on lid which may mate with the first body.

The caps and closures, of which hinged caps and closures and screw caps are a subset, can be made according to continuous compression molding techniques that are well known to persons skilled in the art. Hence, in an embodiment of the disclosure a closure (or cap) comprising the polyethylene copolymer (defined above) is prepared with a process comprising at least one continuous compression molding step.

In one embodiment, the caps and closures (including single piece or multi-piece variants and hinged variants) comprise a polyethylene copolymer as described above and have good organoleptic properties, as well as acceptable toughness and ESCR values. Hence, the closures and caps of this embodiment are well suited for sealing bottles, containers and the like, for example, bottles that may contain drinkable water, or other foodstuffs, including but not limited to liquids that are under an appropriate pressure (i.e., carbonated beverages or appropriately pressurized drinkable liquids).

The closures and caps may also be used for sealing bottles containing drinkable water or non-carbonated beverages (e.g., juice). Other applications, include caps and closures for bottles, containers and pouches containing foodstuffs, such as, for example, ketchup bottles and the like.

The closures and caps may be one-piece closures or two piece closures comprising a closure and a liner.

The closures and caps may also be of multilayer design, wherein the closure or cap comprises at least two layers at least one of which is made of the polyethylene copolymers described herein.

In an embodiment of the disclosure the closure is made by continuous compression molding.

In an embodiment of the disclosure the closure is made by injection molding.

The disclosure is further illustrated by the following non-limiting examples.

### EXAMPLES

Melt indexes, I₂, I₅, I₆ and I₂₁ for the polyethylene copolymer were measured according to ASTM D1238 (when conducted at 190° C., using a 2.16 kg, a 5 kg, a 6.48 kg and a 21 kg weight respectively).

Mₙ, M_{w}, and M_{z} (g/mol) were determined by high temperature Gel Permeation Chromatography with differential refractive index detection using universal calibration (e.g. ASTM-D6474-99). G.P. data was obtained using an instrument sold under the trade name “Waters 150c”, with 1,2,4-trichlorobenzene as the mobile phase at 140° C. The samples were prepared by dissolving the polymer in this solvent and were run without filtration. Molecular weights are expressed as polyethylene equivalents with a relative standard deviation of 2.9% for the number average molecular weight (“Mn”) and 5.0% for the weight average molecular weight (“mW”). The molecular weight distribution (MWD) is the weight average molecular weight divided by the number average molecular weight, mW/Mn. The z-average molecular weight distribution is M_{z}/Mₙ. Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect the columns from oxidative degradation. The sample injection volume was 200 mL. The raw data were processed with CIRRUS® G.P. software. The columns were calibrated with narrow distribution polystyrene standards. The polystyrene molecular weights were converted to polyethylene molecular weights using the Mark-Houwink equation, as described in the ASTM standard test method D6474.

Primary melting peak (° C.), heat of fusion (J/g) and crystallinity (%) was determined using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

The short chain branch frequency (SCB per 1000 carbon atoms) of the polyethylene copolymer was determined by Fourier Transform Infrared Spectroscopy (FTIR) as per the ASTM D6645-01 method. A Thermo NICOLET® 750 Magna-IR Spectrophotometer equipped with OMNIC® version 7.2a software was used for the measurements. Unsaturations in the polyethylene copolymer (terminal, side chain and internal) were also determined by Fourier Transform Infrared Spectroscopy (FTIR) as per ASTM D3124-98. Comonomer content can also be measured using ¹³C NMR techniques as discussed in Randall, Rev. Macromol. Chem. Phys., C29 (2&3), p 285; U.S. Pat. No. 5,292,845 and WO 2005/121239.

Polyethylene copolymer density (g/cm³) was measured according to ASTM D792.

Hexane extractables were determined according to ASTM D5227.

To determine CDBI(50), a solubility distribution curve is first generated for the polyethylene copolymer. This is accomplished using data acquired from the TREF technique. This solubility distribution curve is a plot of the weight fraction of the copolymer that is solubilized as a function of temperature. This is converted to a cumulative distribution curve of weight fraction versus comonomer content, from which the CDBI(50) is determined by establishing the weight percentage of a copolymer sample that has a comonomer content within 50% of the median comonomer content on each side of the median (See WO 93/03093 and U.S. Pat. No. 5,376,439). The CDBI(25) is determined by establishing the weight percentage of a copolymer sample that has a comonomer content within 25% of the median comonomer content on each side of the median

The temperature rising elution fractionation (TREF) method used herein was as follows. Polymer samples (50 to 150 mg) were introduced into the reactor vessel of a crystallization-TREF unit (Polymer Char). The reactor vessel was filled with 20 to 40 ml 1,2,4-trichlorobenzene (TCB), and heated to the desired dissolution temperature (e.g., 150° C.) for 1 to 3 hours. The solution (0.5 to 1.5 ml) was then loaded into the TREF column filled with stainless steel beads. After equilibration at a given stabilization temperature (e.g., 110° C.) for 30 to 45 minutes, the polymer solution was allowed to crystallize with a temperature drop from the stabilization temperature to 30° C. (0.1 or 0.2° C./minute). After equilibrating at 30° C. for 30 minutes, the crystallized sample was eluted with TCB (0.5 or 0.75 mL/minute) with a temperature ramp from 30° C. To the stabilization temperature (0.25 or 1.0° C./minute). The TREF column was cleaned at the end of the run for 30 minutes at the dissolution temperature. The data were processed using Polymer Char software, Excel spreadsheet and TREF software developed in-house.

High temperature G.P. equipped with an online FTIR detector (G.P.-FTIR) was used to measure the comonomer content as the function of molecular weight.

Plaques molded from the polyethylene copolymers were tested according to the following ASTM methods: Bent Strip Environmental Stress Crack Resistance (ESCR) at Condition B at 10% and 100% IGEPAL at 50° C., ASTM D1693; notched Izod impact properties, ASTM D256; Flexural Properties, ASTM D790; Tensile properties, ASTM D638; Vicat softening point, ASTM D1525; Heat deflection temperature, ASTM D648.

The polymer used in Example 1 is a high density polyethylene ethylene/1-hexene copolymer and has a density of 0.957 g/cm³, a melt index I₂ of 0.46 g/10 min and is commercially available from ExxonMobil as ExxonMobil® HPDE HD 9856B.

The polymer used in Example 2 is a high density polyethylene copolymer made with a chromium based polymerization catalyst in a gas phase polymerization process. The Example 2 polymer is an ethylene/1-hexene copolymer and has a density of 0.949 g/cm³, a melt index I₂ of 0.40 g/10 min and is commercially available from NOVA Chemicals as NOVAPOL® HF-Y450-A.

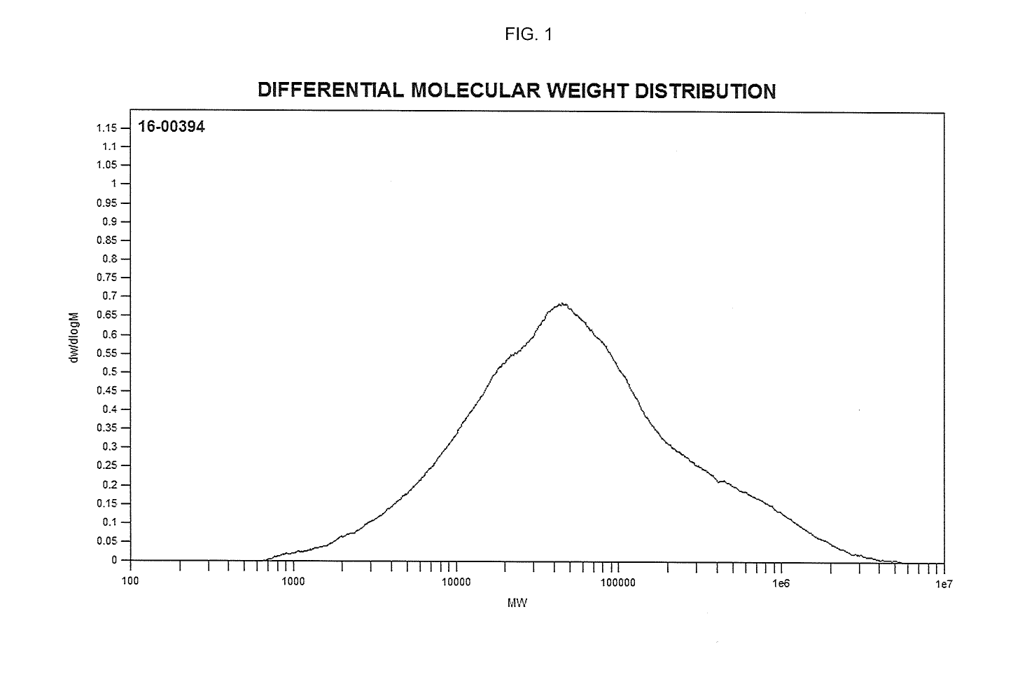

The polymer used in Example 3 is a high density polyethylene copolymer made with a Ziegler-Natta catalyst in a solution polymerization process. The Example 3 polymer is an ethylene/1-butene copolymer, and has a density of 0.950 g/cm³, a melt index I₂ of 0.45 g/10 min and is commercially available from NOVA Chemicals as STAIR® 17A. A G.P. profile for the polymer of Example 3 is shown in FIG. 1.

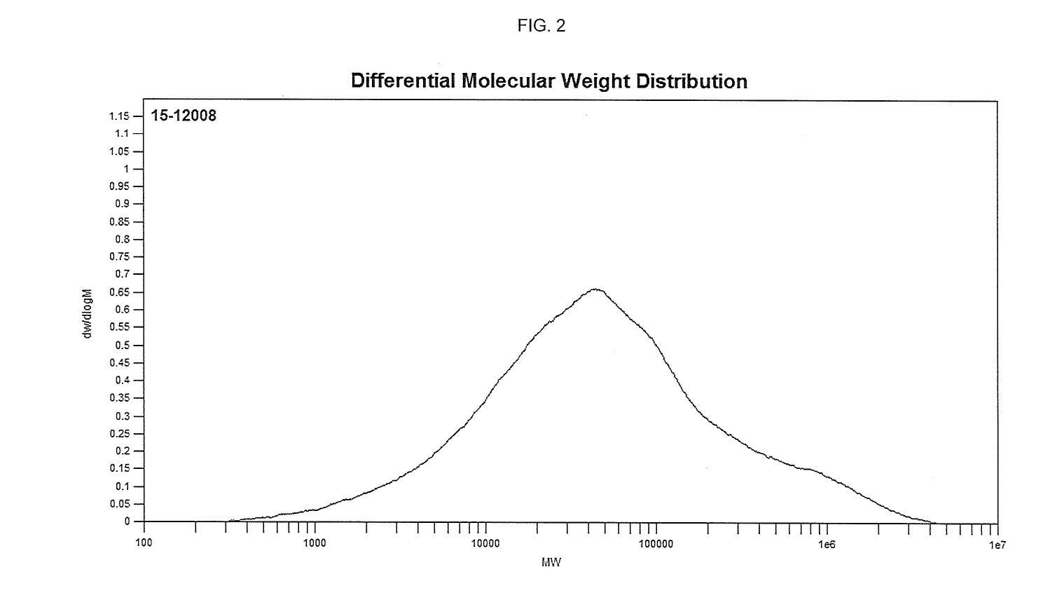

The polymer used in Example 4 is a high density polyethylene copolymer made with a Ziegler-Natta catalyst in a solution polymerization process. The Example 4 polymer is an ethylene/1-butene copolymer, and has a density of 0.957 g/cm³, a melt index I₂ of 0.41 g/10 min and is commercially available from NOVA Chemicals as STAIR 58A. A G.P. profile for the polymer of Example 4 is shown in FIG. 2.

Further data for each of the polymers used in Examples 1-4 is provided in Table 1.

TABLE 1
Polymer Properties

| | Example No. | | | |
|---|---|---|---|---|
| | 1 | 2 | 3 | 4 |
| Density (g/cm³) | 0.957 | 0.949 | 0.950 | 0.957 |
| Melt Index I₂ | 0.46 | 0.40 | 0.45 | 0.41 |
| (g/10 min) | | | | |
| Melt Flow Ratio (I₂₁/I₂) | | 93.8 | 83.9 | 96.7 |
| Stress Exponent | | 1.89 | 1.78 | 1.86 |
| Mₙ | 13959 | 14344 | 17949 | 13786 |
| M_{w} | 146950 | 122544 | 165205 | 160821 |
| M_{z} | 875145 | 602266 | 938029 | 911830 |
| Polydispersity Index (M_{w}/Mₙ) | 10.53 | 8.54 | 9.20 | 11.67 |
| M_{z}/M_{w} | 5.96 | 4.91 | 5.68 | 5.67 |
| Branch Frequency - FTIR | | | | |
| (uncorrected for chain end - CH₃) | | | | |
| Uncorrected SCB/1000 C | <0.5 | 2.7 | 1.2 | <0.5 |
| Uncorrected comonomer content | <0.1 | 0.5 | 0.2 | <0.1 |
| (mol %) | | | | |
| Internal unsaturation (/1000 C) | | 0.050 | 0.070 | 0.040 |
| Side chain unsaturation (/1000 C) | | 0.110 | 0.040 | 0.020 |
| Terminal unsaturation (/1000 C) | | 1.130 | 0.800 | 0.730 |
| Total unsaturation | | 1.29 | 0.910 | 0.790 |
| Comonomer ID | 1-hexene | 1-hexene | 1-butene | 1-butene |
| TREF CDBI₅₀ (%) | 66.8 | 58.3 | 70.8 | 69.1 |
| TREF CDBI₂₅ (%) | 46.6 | 36.2 | 58.3 | 60 |
| DSC | | | | |
| Primary Melting Peak (° C.) | 131.61 | 128.47 | 129.74 | 132.23 |
| Heat of Fusion (J/g) | 219.2 | 194.00 | 207.40 | 210.10 |
| Crystallinity % | 75.57 | 66.89 | 71.51 | 72.46 |
| Environmental Stress Crack | | | | |
| Resistance | | | | |
| ESCR Cond. A at 100% (hrs) | 151 | — | — | — |
| ESCR Cond. B at 100% (hrs) | — | >1154 | 93 | 44 |
| ESCR Cond. B at 10% (hrs) | 66 | 73 | 44 | 26 |
| Flexural Properties (Plaques) | | | | |
| Flex Secant Mod. 2% (MPa) | | 928 | 951 | 1165 |
| Impact Properties (Plaques) | | | | |
| Izod Impact (ft-lb/in) | | 2.50 | 1.40 | 1.90 |
| Other properties | | | | |
| Hexane Extractables (%) | | 0.57 | 0.85 | 0.53 |
| VICAT Soft. Pt. (° C.) - Plaque | | 124.7 | 126.2 | 129.1 |
| Heat Deflection Temp. [° C.] @ 66 PSI | | 64.7 | 62 | 72.9 |

### Neutron Activation Analysis (NAA)

Neutron Activation Analysis, hereafter NAA, was used to determine catalyst residues in ethylene polymer compositions and was performed as follows. A radiation vial (composed of ultrapure polyethylene, 7 mL internal volume) was filled with a polymer product sample and the sample weight was recorded. Using a pneumatic transfer system the sample was placed inside a SLOWPOKE® nuclear reactor (Atomic Energy of Canada Limited, Ottawa, Ontario, Canada) and irradiated for 30 to 600 seconds for short half-life elements (e.g., Ti, V, Al, Mg, and Cl) or 3 to 5 hours for long half-life elements (e.g., Zr, Hf, Cr, Fe and Ni). The average thermal neutron flux within the reactor was 5×10¹¹/cm²/s. After irradiation, samples were withdrawn from the reactor and aged, allowing the radioactivity to decay; short half-life elements were aged for 300 seconds or long half-life elements were aged for several days. After aging, the gamma-ray spectrum of the sample was recorded using a germanium semiconductor gamma-ray detector (ORTEC® model GEM55185, Advanced Measurement Technology Inc., Oak Ridge, Tenn., USA) and a multichannel analyzer (ORTEC model DSPEC Pro). The amount of each element in the sample was calculated from the gamma-ray spectrum and recorded in parts per million relative to the total weight of the polymer sample. The N.A.A. system was calibrated with Specpure standards (1000 ppm solutions of the desired element (greater than 99% pure)). One mL of solutions (elements of interest) were pipetted onto a 15 mm×800 mm rectangular paper filter and air dried. The filter paper was then placed in a 1.4 mL polyethylene irradiation vial and analyzed by the N.A.A. system. Standards are used to determine the sensitivity of the N.A.A. procedure (in counts/pg). The results of NAA analysis (i.e. catalyst residue levels in ppm, present in the polymer based on the weight of the polymer) for Examples 2-4 are given in Table 2.

TABLE 2
NAA of Polyethylene Polymers

| | Example No. | | |
|---|---|---|---|
| | 2 | 3 | 4 |
| Cr (ppm) | 0.72 | <0.1 | <0.2 |
| Al (ppm) | 1.1 | 0.92 | 0.74 |
| Cl (ppm) | 0.19 | 0.06 | 0.05 |
| Mg (ppm) | <2 | <2 | <2 |
| Ti (ppm) | 0.45 | 0.32 | 0.46 |

### Evaluation of Organoleptics/Water Taste Testing

Caps made from the polymer of Example 1 were used for the water taste testing outlined below. The caps were 2.5 g with a surface area of 48.26 cm². 20 caps were used to give a total surface area of 965 cm². Plaque specimens were prepared, and then cut to a predetermined size, for testing the polymers used in Examples 2 and 3.

For the polymers of Examples 2 and 3, a melt was prepared from polymer pellets by using a Brabender compounder at a melt temperature of 170° C. and rpm of 100. Next, 145 g of the melted polymer was pressed into a compression molded plaque having the dimensions 10 inches by 10 inches and a 75 mil thickness. The plaque was wrapped in aluminum foil and stored in the freezer. Plaques were trimmed to a size of less than 24 cm by 21 cm to give a total surface area of 965 cm² and then cut into 6 pieces so that the pieces could be placed in a mason jar. The 6 plaque pieces obtained in this manor for each of Examples 2 and 3, as well as the 20 caps for Example 1 were placed in clean mason jars which were then filled with approximately 1 liter of bottled spring water (REAL CANADIAN Natural Spring Water). Each jar was sealed with a piece of aluminum foil and a lid. For use as a control, bottled spring water was also added to a mason jar in the absence of polymer plaque pieces or caps. Each of the jars (including the control) was placed in a 60° C. water bath for 4 hours. The jars were then removed from the bath and the plaques or caps were removed from the jars. The jars were resealed and all the jars were left to cool to room temperature. Water samples for the taste panel were prepared by pouring the above sample water from each of the jars into separate 2 ounce polystyrene sample cups, each with an identifying code attached to it. For each water sample, a randomly generated 3 digit code was used to ensure the tasting was a blind tasting where panelists were not given information about the water samples they were tasting. Each panelist was provided with an instruction sheet that explains how to conduct the taste test. Before the test, the palette is cleansed with an unsalted cracker. Up to six water samples, including a control, were tasted by each panelist. The same water samples were tasted by each panelist. The water samples were presented in one of four different orders. The panelists ranked each water sample on the following scale to provide a “water taste testing score”: 7=Completely Acceptable (no flavor or taste detected); 6=Moderately Acceptable; 5=Slightly Acceptable; 4=Neither Acceptable nor Unacceptable; 3=Slightly Unacceptable; 2=Moderately Unacceptable; 1=Completely Unacceptable. If a panelist does not detect the control, by assigning the control a score of 5 or higher, the results from that panelist were not included in the final statistical analysis. The results are analyzed using analysis of variance and an average water taste testing score is reported for each water sample as shown in Table 3.

TABLE 3
Organoleptics (Water Taste Testing Score)

| | Example No. | | | |
|---|---|---|---|---|
| | | | | Control |
| | | | | (spring water |
| | | | | stored in glass |
| | 1 | 2 | 3 | jar) |
| Taste Panel Rating - average water | 3.3 | 2.9 | 6 | 6.7 |
| taste testing score | | | | |
| Taste Panel Rating - standard error | 0.44 | 0.48 | 0.3 | 0.09 |

As can be seen from the data in Table 3, each of the water samples containing caps made from the resin of Example 1 or plaque material made from the resin of Example 2 had poor performance using the water taste testing procedure. In contrast, the water samples containing plaque material made from the resin of Example 3, had a performance just below that of the control sample, consistent with very good organoleptic properties for this material. Good organoleptic properties are highly desirable when making closures that are not used in combination with a liner. This is because the closure may come in direct contact with consumable liquid or foodstuffs held within the bottle, container or the like, which the closure is sealing.

A comparison of Table 3 with the catalyst component residue data in Table 2, is consistent with the fact that when higher levels of catalyst residue remain in a polyethylene composition it leads to poorer organoleptic properties. Compare for example, the catalyst residues present in Example 2, with the catalyst residues present in Example 3. Example 2 has 0.72 ppm or chromium present, an aluminum residue level of greater than 1 ppm, and 0.19 ppm of chlorine. In contrast, Example 3 has negligible amounts of chromium present, less than 1 ppm of aluminum and 0.06 ppm of chlorine present. For similar reasons, a person skilled in the art would expect Example 4 to have good organoleptic properties, as it has low levels of catalyst residues present. In contrast, the poor taste testing performance of Example 1, indicates that there may be significant levels of catalyst component residues present.

Non-limiting embodiments of the present disclosure include the following:

Embodiment A. A closure comprising a polyethylene copolymer which has a density of from 0.940 to 0.962 g/cm³, a melt index I₂ of less 1.5 g/10 min, an amount of terminal unsaturation of at least 0.45 per 1000 carbon atoms, fewer than 0.9 parts per million of titanium and fewer than 0.4 parts per million of chromium.

Embodiment B. The closure of Embodiment A wherein the polyethylene copolymer has a density of from 0.947 to 0.960 g/cm³.

Embodiment C. The closure of Embodiment A or B wherein the polyethylene copolymer comprises polymerized ethylene and 1-butene.

Embodiment D. The closure of Embodiment A, B or C wherein the polyethylene copolymer has a molecular weight distribution, mW/Mn of from 5.0 to 16.0.

Embodiment E. The closure of Embodiment A, B, C or D, wherein the closure is made by continuous compression molding.

Embodiment F. The closure of Embodiment A, B, C, D or E wherein the polyethylene copolymer has an environmental stress crack resistance, ESCR, at Condition B at 10% IGEPAL and 50° C. of from 10 to 100 hours.

Embodiment G. The closure of Embodiment A, B, C, D, E or F wherein the polyethylene copolymer has a total amount of unsaturation of at least 0.50 per 1000 carbon atoms.

Embodiment H. The closure of Embodiment A, B, C, D, E, F or G wherein the polyethylene copolymer has an average water taste testing score of greater than 4.

Embodiment I. The closure of Embodiment A, B, C, D, E, F, G or H wherein the polyethylene copolymer is made in a solution phase polymerization reactor.

Embodiment J. The closure of Embodiment A, B, C, D, E, F, G, H or I wherein the polyethylene copolymer is made with a Ziegler-Natta catalyst.

What is claimed is:

1. A closure comprising a polyethylene copolymer which has a density of from 0.940 to 0.962 g/cm³, a melt index I₂ of less 1.5 g/10 min, an amount of terminal unsaturation of at least 0.45 per 1000 carbon atoms, fewer than 0.9 parts per million of titanium and fewer than 0.4 parts per million of chromium.

2. The closure of claim 1 wherein the polyethylene copolymer has a density of from 0.947 to 0.960 g/cm³.

3. The closure of claim 1 wherein the polyethylene copolymer comprises polymerized ethylene and 1-butene.

4. The closure of claim 1 wherein the polyethylene copolymer has a molecular weight distribution, M_{w}/Mₙ of from 5.0 to 16.0.

5. The closure of claim 1 wherein the closure is made by continuous compression molding.

6. The closure of claim 1 wherein the polyethylene copolymer has an environmental stress crack resistance, ESCR, at Condition B at 10% IGEPAL and 50° C. of from 10 to 100 hours.

7. The closure of claim 1 wherein the polyethylene copolymer has a total amount of unsaturation of at least 0.50 per 1000 carbon atoms.

8. The closure of claim 1 wherein the polyethylene copolymer has an average water taste testing score of greater than 4.

9. The closure of claim 1 wherein the polyethylene copolymer is made in a solution phase polymerization reactor.

10. The closure of claim 1 wherein the polyethylene copolymer is made with a Ziegler-Natta catalyst.
